(19) United States
(12) Patent Application Publication
(10) Pub. No.: US 2016/0034265 A1
(43) Pub. Date: Feb. 4, 2016

(54) Method for Bulk App Loading on Mobile Devices

(71) Applicant: Tu Nguyen, Fremont, CA (US)

(72) Inventor: Tu Nguyen, Fremont, CA (US)

(21) Appl. No.: 14/818,229

(22) Filed: Aug. 4, 2015

Related U.S. Application Data
(60) Provisional application No. 62/032,772, filed on Aug. 4, 2014.

(51) Int. Cl. G06F 9/445; G06Q 20/22; H04L 29/08

(52) U.S. Cl. CPC G06F 8/61; H04L 67/34; G06Q 20/22

(57) ABSTRACT

A method of quickly installing a set of apps on a used smartphone, activating them by a process that does not require the user to set up multiple accounts, and a method of financing the process.

### CROSS-REFERENCE TO RELATED APPLICATIONS

The present application takes priority from Provisional App. No. 62/032,772, filed Aug. 4, 2014, which is herein incorporated by reference.

### BACKGROUND

As electronic devices evolve faster and faster, consumers upgrade them more and more often. This increases the number of used electronic devices in existence. Often, such used electronic devices are perfectly usable and work perfectly well, but due to the rapid evolution, are no longer usable by most consumers.

There is a vast and underserved market for electronic devices such as smartphones in many countries, and markets for such electronic devices are rapidly emerging. Since smartphones are typically low-power, easily portable, and easy to use for applications such as Internet access, money transfer, email, and other such applications, many people living in these countries are already turning to smartphones, rather than computers, as their primary computing device. Used smartphones would be a good way of expanding the market for smartphone apps and Internet connectivity in emerging markets.

App makers or social media companies such as Facebook or Twitter typically spend large amounts of money on new customer acquisition. It is desirable to facilitate new customer acquisition for such companies by making services such as Facebook, Twitter, or other online apps or services, easily available and usable to consumers in emerging markets.

A need exists for a method of quickly and easily refurbishing used smartphones for emerging market applications that will render such smartphones easily usable by consumers who are new to smartphones and new to the Internet in general, and encourage such consumers to join social media services such as Facebook or Twitter.

### SUMMARY OF THE INVENTION

An object of the present invention is to provide a method for easily creating accounts on multiple social media services and other applications.

Another object of the present invention is to provide a method for creating accounts on multiple social media services and other applications for users who have low literacy skills.

Another object of the present invention is to provide a method for compensating manufacturers/refurbishers for providing new users to app companies.

The present invention may be used with applications such as social media services (i.e. Facebook, Twitter, Google+), banking applications, email applications, or any other applications requiring an account to be used.

The method of the present invention comprises installing a provisioning application on the mobile device wherein the provisioning application receives login information from a user, and creates accounts for the user on at least two applications using this login information. The applications can be social media applications, banking applications, email applications, games, or any other application for which an account is required.

In an embodiment, the method of the present invention also comprises deleting all the data on the used mobile device prior to installing the provisioning application.

In an embodiment, the provisioning application downloads the applications onto the device after receiving login information from the user.

The provisioning application can create the accounts on each of the applications automatically based on the user's login information, or it may use a pre-configured account and set it up for the user for each application. The company that owns the application may create a plurality of pre-configured accounts for this purpose.

In an embodiment, the manufacturer/refurbisher that owns the provisioning application may be compensated for each of the pre-configured accounts, either when they are created, when they are assigned to a user, or when a user first uses them.

In an embodiment, the step of the user's inputting information into the provisioning application is performed in such a way that requires no or minimal literacy skills from the user. This may be accomplished by providing verbal or visual prompts.

### LIST OF FIGURES

FIG. 1 shows a flowchart of the method of the present invention.

FIG. 2 shows a flowchart of the installation method of the app of the present invention.

FIG. 3 shows two sample screens from the app of the present invention.

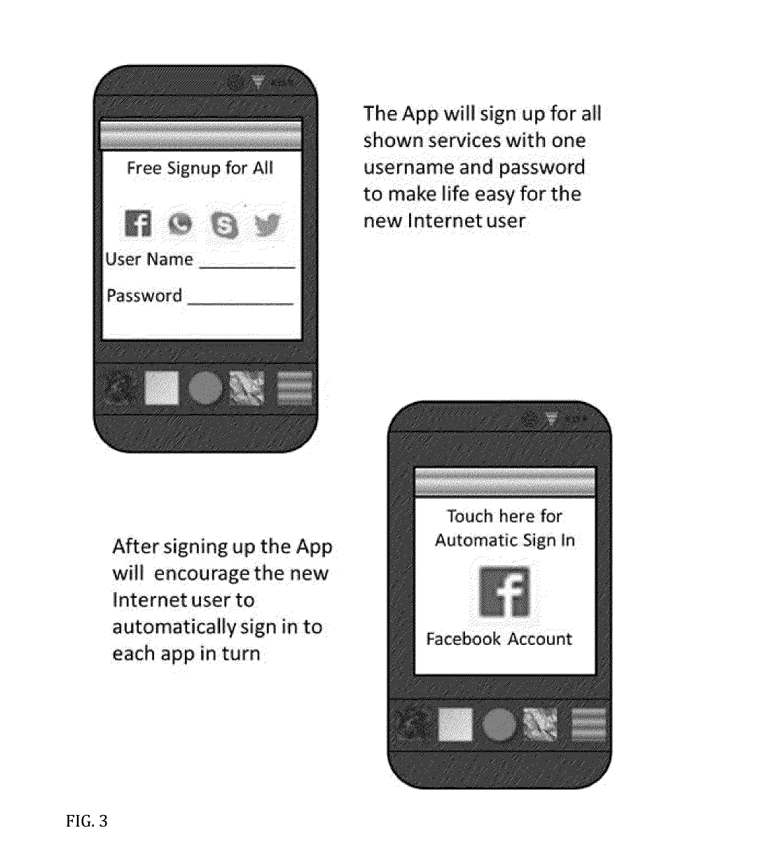

### DETAILED DESCRIPTION OF THE PREFERRED EMBODIMENT

In the preferred embodiment of the present invention, the following method is practiced on a used smartphone in order to render it easily usable for a new consumer. For purposes of the present disclosure, the word “smartphone” includes other mobile devices such as tablets. The method may also be practiced on a new smartphone.

In the preferred embodiment, a used smartphone is received by a refurbishing facility. The refurbishing facility wipes the data on the smartphone, repairs any problems that require repair, and then installs the apps that would render the smartphone useful to a consumer who is new to smartphones in general. For example, such apps may include email, Facebook, Twitter, WhatsApp, online banking or money transfer, and so on. The language on the smartphone is preferably customized to the language of the country for which it is intended. In an embodiment, a text-to-voice feature is installed for those consumers who are unable to read. Preferably, the set of apps installed on the smartphone comprises at least the following apps: Facebook, Twitter, Skype, Whatsapp. Other apps may also be included.

While the apps may be installed by any standard method available in the art, in the preferred embodiment of the present invention, the apps are loaded by a machine that is designed to install multiple apps to many mobile devices simultaneously, as is commonly used for OEM installation of non-removable apps to mobile devices before the devices are released to the market.

In the preferred embodiment, the accounts for each app are linked, so that a consumer does not have to create a new Facebook account, then a separate new Twitter account, then a separate new email account, and so on. The setup stage would be too complicated for an inexperienced consumer. Thus, in the preferred embodiment, the account creation stage preferably comprises the following steps:

a. Consumer enters their name in the name block, and a preferred password in the password block;

b. An account is created for the consumer, using their name as the username and their preferred password as the password, on every app installed on the smartphone; alternately, a pre-existing account is given the consumer name and password. Pre-existing accounts may be created and exist as part of a business arrangement for tracking account activations.

c. After all accounts are created the creation app encourages the consumer to log in to each account.

d. Consumer is able to log in to every app installed on the smartphone.

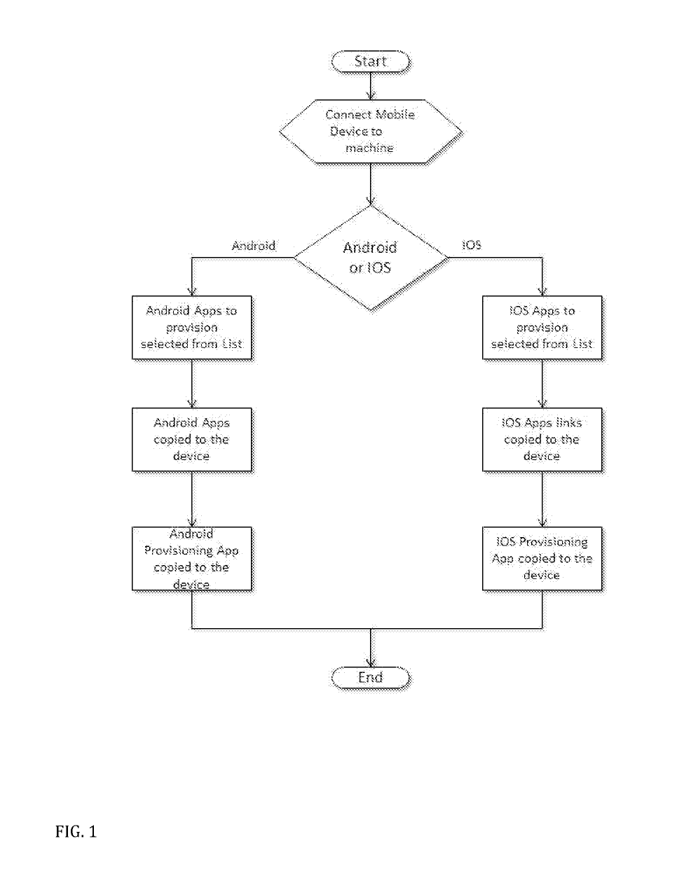

FIG. 1 shows the setup step for the provisioning app of the present invention. First, a used smartphone is connected to a machine that deletes all the data on the device and gets it ready for installation of new apps. The machine then determines which operating system the smartphone is running. Depending on the operating system, the machine then selects apps to pre-load (i.e. Facebook, Twitter, online banking, etc.), and copies them onto the device. The apps are preferably selected by an operator. Then, the provisioning app itself is copied onto the device.

In an embodiment, the provisioning app is loaded onto a new smartphone by the same type of machine. In that embodiment, deleting the data is obviously not necessary. The process can be performed by a manufacturer as well as by a refurbisher.

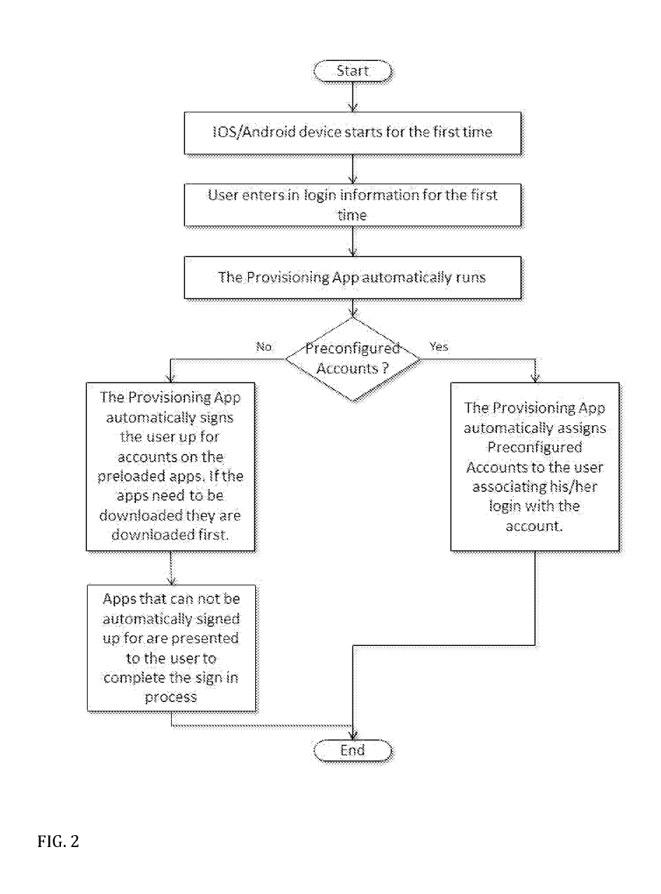

FIG. 2 shows the usage of the provisioning app. When the smartphone starts for the first time, a user is prompted to enter their login information and the provisioning app runs automatically. In one embodiment, the provisioning app simply signs the user up for accounts on all the pre-loaded apps on the device. If an app is missing, the provisioning app prompts the smartphone to download it prior to signing the user up for an account. If an app does not allow automatic sign-up, it is presented to the user separately to complete the sign-up process.

In another embodiment, the app creator (i.e. Facebook, Twitter, or another company that manufactures an app) provides a block of pre-configured accounts to the refurbishing company that provisions the smartphone. If the provisioning app is prompted to use pre-configured accounts, it simply selects the next pre-configured account from the list for the user and associates it with the user's login and password.

FIG. 2 shows two sample screens for the consumer to use in signing up for their new account. The first screen shown in the Figure allows the consumer to enter their preferred username and password. After the consumer does so, the app encourages the consumer to log into each account created—the second screen shows the Facebook app. The consumer can then easily log into each app installed on the smartphone.

In the preferred embodiment, auditory or textual instructions and explanations are also provided to guide the consumer through the setup process. For the illiterate consumer, text-to-speech is used throughout, and may be accompanied by visual images to aid comprehension.

In the preferred embodiment, the app manufacturers or social media companies pay for this service provided by the manufacturer/refurbisher. Since social media companies typically pay a certain amount for customer acquisition, and since the manufacturer/refurbisher is acquiring new customers for them, social media companies pay a deposit of a certain percentage of the customer acquisition fee every time their apps are installed on a smartphone by the manufacturer/refurbisher. Then, when a customer first uses the account created by the method of the present invention, the social media company that owns the account pays the rest of the customer acquisition fee to the manufacturer/refurbisher. This enables the social media company to acquire new customers in emerging markets or other underserved populations, and enables the manufacturer/refurbisher to fund its operations. In the preferred embodiment, the social media company pays 20% of its typical customer acquisition fee when its app is installed on a used smartphone by the manufacturer/refurbisher. The social media company then pays 80% of its typical customer acquisition fee when a user first uses their social media account.

In the preferred embodiment the app owner would provide a method such as an ‘identification cookie’ for determining when a new user had established an account by use of the invention; or would provide special accounts already configured for occupancy by the new user when the new account was established by the new user through use of the invention. Preferably, new accounts are established using the IMEI number of each phone (which is unique) by companies such as Facebook, Twitter, and other companies that would want new users to establish accounts using the method of the present invention. Should such a company not want to establish accounts itself, the manufacturer/refurbisher can, by means of the app, automatically sign up for its service using the phone's IMEI number as the username and a hash of the IMEI number as the password.

Exemplary embodiments have been described above. It will be understood that the present invention encompasses equivalents that fall into the scope of the present invention as understood by a person of reasonable skill in the art.

1. A method for refurbishing a used mobile device, comprising:
deleting all the data on the used mobile device;
installing a provisioning application on the used mobile device,
wherein the provisioning application is configured to:
receive login information from a user;
create an account for the user on at least two applications using the login information.

2. The method of claim 1, wherein the at least two applications are chosen from the following group of categories: social media applications, banking applications, email applications, chat applications, voice-over-IP applications, game applications, entertainment applications.

3. The method of claim 1, further comprising:
after receiving login information from a user, downloading at least two applications onto the used mobile device.

4. The method of claim 1, wherein the step of creating an account comprises:
using the user's login information to generate login information on each of the at least two applications.

5. The method of claim 1, wherein the step of creating an account comprises:
pre-configuring a plurality of accounts on at least one of the applications;
assigning one of the plurality of accounts to the user.

6. The method of claim 5, wherein the step of pre-configuring a plurality of accounts on at least one of the application comprises:
for each account, using the IMEI number of a used mobile device on which it is installed as a username;
using a hash of the IMEI number of the used mobile device as a password.

7. The method of claim 5, wherein the at least one of the applications is owned by an app company, wherein the provisioning application is owned by a refurbisher, further comprising at least one of the following steps:
the app company providing compensation to the refurbisher for each of the plurality of accounts when they are pre-configured;
the app company providing compensation to the refurbisher for each of the plurality of accounts when it is assigned to a user;
the app company providing compensation to the refurbisher for each of the plurality of accounts when a user first uses the account.

8. The method of claim 1, wherein the step of receiving information from a user is performed in a way that does not require literacy skills.

9. The method of claim 1, wherein the step of receiving information from a user is performed in a way that requires minimal literacy skills.

10. The method of claim 8, wherein the step of receiving information from a user comprises giving the user one or more of the following: verbal prompts, visual prompts.
